(19) United States
(12) Patent Application Publication
(10) Pub. No.: US 2006/0245500 A1
(43) Pub. Date: Nov. 2, 2006

(54) Tunable wavelet target extraction preprocessor system

(76) Inventor: David Yonovitz, Del Mar, CA (US)

Correspondence Address: Herbert Joe, 2809 Creek Side Dr., Edmond, OK, 73003-4231, US

(21) Appl. No.: 11/012,754

(22) Filed: Dec. 15, 2004

(51) Int. Cl. H04B 1/66; H04N 5/225; H04N 11/02; H04N 11/04; H04N 7/12

(52) U.S. Cl. 375/240.19; 348/169

(57) ABSTRACT

The present invention is a target tracking system for enhanced target identification, target acquisition and track performance that is significantly superior over other methods. Specifically, the target tracking system incorporates an intelligent Tunable Wavelet Target Extraction Preprocessor (TWTEP). The TWTEP, which defines target characteristics in the presence of noise and clutter, 1) enhances and augments the target within the video scene to provide a better tracking source for the externally provided Track Process, 2) implements a tunable target definition from the video image to provide a highly resolved target delineation and selection, and 3) utilizes a weighted pseudo-covariance technique to define target area for shape determination, extraction, and further processing.

### BACKGROUND OF THE INVENTION

1. Field of the Invention

The present invention broadly relates to a new and vastly improved target tracking system for various system applications, and includes substantially more accurate target definition, target selection, target acquisition and track performance.

2. Background Information

Motion is a primary visual cue for humans. To focus on or scrutinize a particular moving object, the moving object must be tracked or followed. Active and passive imaging technologies are employed in a variety of applications where there is an inherent need to accurately track an object as it moves quickly through space within a cluttered and dynamic background.

A Pointing/Tracking system is an organization of functions that externally or autonomously defines a stationary or moving object (target) within a video scene and stabilizes the position of the target within the sensor's video boundary by sending sensor movement commands.

Pointing/Tracking systems are used in many various situations when one wishes to maintain a constant observation of a moving object of interest. As the object and/or sensor moves, the object is maintained at a constant location within the image field of view. Once stabilized in position, important characteristics of the target may be ascertained, e.g., physical form, motion parameters, legible descriptive information, temperature (notable in infra-red sensitive sensors), etc. Such information may be very useful in many situations, including commercial, industrial, or military applications.

Typically, a closed loop, target tracking system, illustrated in FIG. 15, consists of the following sub-functions:
Sensor: A video camera or other device that outputs a video signal and is capable of commanded movement in horizontal and vertical axes.
Track Preprocessor: An optional function that is utilized to aid the follow-on processing functions by enhancing the probability of accurately defining a target within a video scene.
Track Processor: A function that determines the current position of a moving target within a video scene.
Track Error Generation: A function that determines the commands necessary for a sensor positioning system. These commands dictate the movement of the video sensor to maintain the target at a specified position within the image field of view.
Sensor Command Process: A function that commands the sensor movement.

In Pointing/Tracking applications, there are typically two critical phases: i) Acquisition, and ii) Track. In the Acquisition Phase, an object's location in space is externally or autonomously defined and its relative motion within the image field of view is reduced to below a given threshold. The Track Phase is then initiated and the object is maintained at a given location within the field of view within a given tolerance. Within nominal condition boundaries, these sequential phases of operation are readily attainable with current technologies and inventions.

It is under “stressful” conditions that these systems may not yield effective and accurate target acquisition or stable tracking. Stressful conditions may include any of the following on this non-exclusive list:
Low target Signal-to-Noise Ratio (SNR),
Low target Signal-to-Clutter Ratio (SCR),
Little relative motion between target and background,
Non-maskable target induced clutter (target exhaust gasses or plumes), and/or
Small target area.

Under stressful conditions, each of the Acquisition and Track Phases presents unique problems that must be overcome to accomplish a successful and accurate resultant tracking scenario. For example, under stressful operational conditions, current Pointing/Tracking systems may lock on to a wrong target. Indeed, it may acquire and/or track (or misacquire or mistrack) an unspecified target without fault, but fail a specific mission.

In addition to the typical Track Phases, mission requirements often dictate a defined Track “Type.” A Track Type is defined to be the overall goal of a Track Process. Different objectives of mission scenarios will define the Track Type to be accomplished. In other words, for a given scenario, it may be more advantageous to track a front (leading) edge or another single or unique target feature, rather than track all the available features of a target.

The intelligent Tunable Wavelet Target Extraction Preprocessor (hereinafter referred to as “TWTE Preprocessor,” or “TWTEP”), the subject of the proposed invention, is the key to a Pointing/Tacking system that has increased accuracy target acquisition and track performance.

To aid the Acquisition and Track performance of Pointing/Tracking systems and mitigate the problems encountered while operating within the confines of stressful conditions, this invention proposes a unique implementation of a Track Preprocessor Function. With its inclusion, more robust systems will result with a higher probability of mission success. While this invention concentrates upon the preprocessing of sensor information to accomplish the overall goals, the other subfunctions of Pointing/Tracking systems are either given for a tracking scenario, are unique to an implementation, or are not the topic of this invention.

With the incorporation of the intelligent TWTE Preprocessor in Pointing/Tracking systems, acquisition, and track performance can be improved over other current methods. An added benefit of the TWTE Preprocessor is that it may also aid systems required to accomplish target identification.

The methodologies and techniques implemented herein are specified for systems utilizing video sensors. However, the same dynamics exist in other tracking systems that utilize non-video sensors as sources, like radar tracking systems, or other systems that process 1 to n-dimensional sensor inputs. The same signal processing techniques may be utilized to improve their overall system performance parameters.

The Nature of Video.

A video signal from the sensor is an electronic representation of a scene presented in a time sequential manner. That is, in the typical case, a video sensor takes a “snapshot” of a video scene at a periodic rate (60 times per second, US Standard “field” rate) and outputs the scene for processing. Due to the snapshot nature of the video signal, each scene is a representation of the real scene at a specific time.

A video field is defined in terms of horizontal and vertical scans. To facilitate digital implementations, a tracking system views a real scene in terms of horizontal and vertical coordinates known as picture elements, or pixels. Digital processing is accomplished in units of pixels, defining position within a video image.

Once a target is defined, the tracking system detects the target's image within each succeeding field of video. For each video field, a calculation is completed to determine the relative movement between the target's former and current positions. The sensor is then commanded to move in horizontal and vertical axes to return the target image to a given position (in pixels). This methodology will maintain a stabilized target position within the image scene under normal or non-stressful conditions.

Tracking System Performance Criteria:

Two key measurements of tracking system performance are:
The ability to acquire targets, and
The ability to maintain low track error, which is the error associated with stabilizing the target in the image scene, i.e., a measurement of the ability to maintain the target at the same pixel coordinates over time.

Acceptable target acquisition and track performance may be readily attainable under “nominal” conditions by current systems. Generally, nominal conditions consist of scenarios involving:
Targets of high Signal-to-Noise Ratio (SNR) relative to clutter within the image, or
Targets that have easily discernable motion relative to other possible targets or clutter.

Given these non-stressful conditions, current tracking systems can typically attain acceptable performance levels without the aid of a Track Preprocessor. It is in the absence of these favorable or non-stressful conditions when a Track Preprocessor is necessary to meet performance standards. This is the thrust of this invention. The TWTE Preprocessor enhances the video signal prior to the Track Process function in order that the key measurements of tracking system performance defined above can be attained. Different stressful scenarios will require that the video be enhanced in different ways to meet overall performance requirements. In fact, the TWTE Preprocessor described herein is capable of meeting this demand by dynamically or actively “tuning” the video enhancement in different ways commensurate with the fast changing scenarios.

From the point of view of the Track Process and downstream functions, the stressful scenarios require the enhancement of video to improve the SNR and allow maintaining low track error. The TWTE Preprocessor will thus allow the remainder of the closed loop tracking functions to accomplish their specified task.

Specifically, adverse conditions should and can be parameterized in better and more accurately ways. As such, the scenarios under which the tracking system must perform must be considered. For each scenario, the adverse conditions can be defined. It is under these conditions which the current invention, the TWTE Preprocessor, addresses.

A target has a useable SNR when it is discernable from scene background and other scene components. It is important to define tracking parameters from this perspective because should these parameters fall below useable requirement by the Track Process Function, the entire tracking process will be degraded or fail. Given scenario type parameters, the TWTE Preprocessor can effectively improve target SNR. The tunable aspect of the TWTE Preprocessor facilitates this need. Improving SNR allows for faster target acquisition time. Because the target (including its boundaries within the scene) is better defined, track error is minimized and associated track jitter (short-term stabilization error) performance improves. Target position and size are typical definition required by Track Process Functions. As the target definition and boundaries are improved, i.e., with higher SNR, the Track Processor Function calculations will be of higher accuracy and more consistent over consecutive video fields.

Relative motion between scene components is also an important scenario parameter. High relative motion will allow for easier acquisition and lower track error. If a target is moving relative to all other scene components, the other components will be undefined in the scene and either detected by the Track Process as blurred undefined components or not at all. There are two cases to be considered in which the TWTE Processor provides unique advantages:
1) Modern Track Process functions typically use a correlation algorithm to determine current target position information on a video field basis. Associated with this process, an integrator of pixel information over time in some form is typically used. This has the advantage of averaging potential targets along with clutter over time. Overall, this has the effect of improving the SNR of the target and lowering the SNR of the clutter. The target pixel locations will average to a defined target because it is stationary in its image location, while the clutter, at a given pixel location, will average to a blur at best. Thus, the target will be the best-defined component in the image scene. Typically, the averaging time constant is settable, depending upon scenario parameters. The integrator, while sufficing for many scenario applications, presents an inherent problem. With an integrator implementation, there is an associated time lag. This time lag can prove detrimental to many scenarios. The TWTE Preprocessor would obviate time lag and its associated problem, as there is no successive video field memory required in the TWTE Preprocessor algorithms. (A field video memory may be utilized as a “backup” algorithm).
2) Even more important, if. there is little relative motion between the target and clutter, a modern Track Process Function may be more apt to correlate upon the clutter rather than the intended target. This would be especially true if the clutter presented itself as a higher correlation than the target, e.g., a relatively small target versus a large amount of clutter in the image. In this situation, a track would occur, but the system would be engaged on the wrong object. Therefore, the scenario would be a failure. An external source would be required, manually or by automated intervention, to reattempt a track of the intended target. The TWTE Preprocessor would have a high probability of succeeding in this scenario because it would negate the video image clutter prior to processing by the Track Process Function. Only the intended target would be presented for further processing, and the need for an external source would also be negated. The TWTE Preprocessor would make certain likely scenarios, including those
   under stressful conditions, have a high probability of success, providing a substantial improvement over automated tracking systems. For example, in a scenario with a sensor pointing down a road at a target, the target is far away such that its view in the video image is small. Within the video scene is clutter, telephone polls, large rocks, and houses that are large and in constant view of the video scene. The target is moving down the road towards the sensor slowly. The clutter is stationary. A typical current correlation tracking system without the TWTE Preprocessor will have all this video information presented for computation. The result will most likely be a strong correlation for the clutter and a weak correlation for the actual target. The intended target will eventually move from the scene while the system maintains a valid track of the clutter!

On the other hand, a tracking system's Track Process Function employing the TWTE Preprocessor would be presented most or all of the target information and little or none of the clutter information. This system would have a high probability of success. In this scenario, the tunable nature of the TWTE Preprocessor would enable this occurrence.

Other like scenarios exists where the target is relatively small and there is little relative motion between target and clutter. These situations might likely occur where targets to be tracked are located at large distances from a sensor. For examples, airborne targets with cloud clutter, slow moving targets in space with star clutter, spaceborne satellite applications looking at targets on the earth, etc.

In addition, the TWTE Preprocessor has other potential advantages important to tracking different types of targets under varying scenarios. They include:

“Plume” Negation

Plumes are the effects of hot exhaust gasses emitted from jet engines that are visible when observed using sensors sensitive to infrared or other wavelengths of light. The human eye can not observe these wavelengths. However, many tracking applications, especially military, depend upon these types of sensors. This problem is especially observable when the effects on the video of the plume become appreciable relative to the observed target size. Hot exhaust gasses are normally observed as highly transient with a possibly intense core (dependent upon exhaust gas temperatures and contrasting background parameters). The transient properties of these effects on the video scene and subsequent attempts at tracking can have a highly deleterious effect on overall track performance and success. An attempt to track a target with highly transitory properties will destabilize efforts to hold a target at a singular position in the video scene due to a rapidly changing target definition presented to the Track Processor. (Modern trackers attempt to negate this problem by the use of a video pixel “averaging” technique. However, as stated earlier, an averaging of target pixel information will create a hazard to target acquisition and a typically unacceptable lag in target tracking). By Temporal Filtering, Spatial Filtering, and/or Spectral Filtering techniques, the TWTE Preprocessor may be tuned to negate Plume effects and their negative affects on tracking.

Target Identification

By comparing normalized target features (possibly in a given set of spectra) to known targets, a potential identification of target may be accomplished.

Target Orientation, Direction Bearing

By examining and comparing target features (possibly in a given spectra) to known targets and orientation, a determination of the target movement properties may be derived.

Target Feature Extraction

Target Feature Extraction is the elimination of all but a defined feature(s) or the enhancement of a given feature(s) of a target within the video scene to be presented to the Track Processor. By doing so, should a known or perceived target have a portion that is known to detract from or enhance track performance, it can be eliminated or emphasized within the video scene before presentation to the Track Processor.

Temporal Filtering

Temporal filtering is similar to Target Feature Extraction except target features are either eliminated or enhanced based upon presence within a video field over a period of time.

Spatial Filtering

A filtering technique where upon targets are either eliminated or emphasized based upon size with in the video scene.

Spectral Filtering

A filtering technique whereupon targets (clutter) are either eliminated or emphasized based upon their frequency-related properties (in wavelets terms, “translation,” “scale,” and “amplitude”). Images are comprised of a set of spectrum which when summed make up the composite scene. The total spectrum can be divided into sub-spectra of a given bandwidth. The lower bandwidth spectra consist of elements of the image that are consistent in amplitude (e.g., blocks within the image), while gradients are characteristic of higher bandwidth spectra. By processing these spectra in various ways to match a target and scenario, the TWTE Preprocessor can be tuned to allow only certain characteristics of the image to be passed on to the Track Processor. For example, many applications use spectral filtering to eliminate noise within the image by negating high gradient bandwidth spectra. The TWTE Preprocessor either eliminates or emphasizes certain bandwidths of the image to alter the video scene to improve track performance. During preprocessing, resultant target edges or large consistent target areas might be better defined or de-emphasized to fit the scenario. If the spectra of background clutter are known or can be evaluated, these clutter features could be eliminated so as not to detract from performance.

3. Background Art

Current video tracking processors utilize a variety of processing techniques or algorithms, e.g., centroid, area balance, edge and numerous correlation tracking implementation concepts. However, unlike the proposed invention, most of these video tracking processors are inherently incapable of accurately determining target boundary or shape based on a set of known or unknown conditions.

U.S. Pat. No. 6,393,137, entitled “Multi-resolution object classification method employing kinematic features and system therefore” and issued on May 21, 2002, is a multi-resolution feature extraction method and apparatus that utilizes Wavelet Transform to “dissect” the image and then compare it to “pre-dissected” images. This is done to identify the object, one of possibly many, within the image, that is the choice of track. They then use the coordinates of this image to define a track point.

However, unlike the proposed invention, patent '137 does not modify the video for track purposes. Patent '137 uses a different algorithm for track object differentiation and, most importantly, it uses a “look-up” database to determine the target within the image. The metrics developed to determine the object to track are based upon a classic object “classifier.” The TWTE Preprocessor of the proposed invention does not incorporate such a “classifier.”

The TWTE Preprocessor of the proposed invention assumes the object closest to the designated coordinates is the object to be tracked. This is done because in the TWTE Preprocessor, there will only be objects within the modified video that are meaningful as object(s) to be tracked. Objects that do not fit the target attributes are not within the modified video images. Also, there is no pre-filtering accomplished in patent '137.

Furthermore, the invention of patent '137 is not “tunable” like the proposed invention, i.e., '137 is put together to apply to a given scenario, with little or no real-time flexibility.

U.S. Pat. No. 6,678,413, entitled “System and method for object identification and behavior characterization using video analysis” and issued on Jan. 13, 2004, is capable of automatically monitoring a video image to identify, track and classify the actions of various objects and the object's movements within the image.

However, the proposed invention is substantially different in that the algorithm in the '413 patent does not modify the video for further processing, whereas the proposed invention (TWTE Preprocessor) “tunes” the video for further processing. Also, the '413 patent identifies a region of the field of view as the target and identifies characteristics about this region and does not identify an exact shape of a target, like the proposed invention. Patent '413 merely encompasses the target region and, as such, it would yield many inaccuracies.

U.S. Pat. No. 6,674,925, entitled “Morphological postprocessing for object tracking and segmentation,” issued on Jan. 6, 2004, relates to object tracking within a sequence of image frames, and more particularly to methods and apparatus for improving robustness of edge-based object tracking processes.

However, the proposed invention is substantially different in that the tracker of patent '925 is an “edge” tracking system. However, edge trackers for a vast number of scenarios are not effective. For example, in patent '925 the algorithm utilized incorporates memory of the previous frame to process the current frame. An error made during a previous frame will propagate to successive frames. Thus, a loss of track is likely. The TWTE Preprocessor of the proposed invention has no such dependence upon history of the video, as it processes each video field independently to obtain an output.

U.S. Pat. No. 6,567,116, entitled “Multiple object tracking system,” issued on May 20, 2003. It is a system for tracking the movement of multiple objects within a predefined area using a combination of overhead X-Y filming cameras and tracking cameras with attached frequency selective filter.

However, the proposed invention is substantially different in that patent '116 tracks “cooperative” targets, i.e., targets that have been modified to be easily identifiable by the tracking system. Many targets employ countermeasures to disguise their tracking properties, which would render use of the technology in the '116 patent ineffective. The TWTE Preprocessor of the proposed invention depends upon no such aid and therefore effective on tracking disguised targets with countermeasures.

U.S. Pat. No. 6,496,592, entitled “Method for tracking moving object by means of specific characteristics,” issued on Dec. 17, 2002, is a method for the detection and tracking of moving objects, which can be implemented in hardware computers. The core of the described method is a gradient integrator, whose contents can be permanently refreshed with a sequence of image sections containing the target object. Different method steps for processing the image sections reduce the number of required calculation operations and therefore assure sufficient speed of the method.

However, the proposed invention is substantially different in that more information is used in the track process because of the TWTE Preprocessor of the proposed invention, which will provide a more accurate, stable track of the target.

U.S. Pat. No. 5,684,886, entitled “Moving body recognition apparatus,” issued on Nov. 4, 1997 and is a moving body recognition apparatus that recognizes a shape and movement of an object moving in relation to an image input unit by extracting feature points.

However, the proposed invention is substantially different in that patent '886 does not define feature points. This is necessary to determine object position, which is why the TWTE Preprocessor of the proposed invention is more concerned with the definition of the object definition—all necessary for accurate and stable tracking.

U.S. Pat. No. 5,602,760, entitled “Image-based detection and tracking system and processing method employing clutter measurements and signal-to-clutter ratios,” issued on Feb. 11, 1997. It relates generally to electro-optical tracking systems, and more particularly to an image detection and tracking system that uses clutter measurement and signal-to-clutter ratios based on the clutter measurement to analyze and improve detection and tracking performance.

However, the proposed invention is substantially different in that Patent '760 computes the Wavelet Transform of the incoming video and utilizes only partial information (control parameter) resulting from this calculation. The Wavelet Transform is not used to modify the video for track processing, as is the case in the TWTE Preprocessor—Track Processor combination.

U.S. Pat. No. 5,430,809, entitled, “Human face tracking system,” issued on Jul. 4,1995. It relates generally to a video camera system and is suitably applied to the autonomous target tracking apparatus in which the field of view of a video camera can track the center of the object, such as a human face model.

However, the proposed invention is substantially different in that Patent '809 emphasizes the use of image tracking to extract and follow a facial property within consecutive images. It incorporates an algorithm that looks for a given facial color (hue), finds a peak gradient, and correlates that with a like parameter from a consecutive video image. None of these qualities are the prime objective of the TWTE Preprocessor of the proposed invention.

U.S. Pat. No. 4,849,906, issued on Jul. 18, 1989, is entitled “Dual mode video tracker.” Point and area target tracking are employed by a dual mode video tracker which includes both a correlation processor and a centroid processor for processing incoming video signals representing the target scene and for generating tracking error signals over an entire video frame. Similarly, U.S. Pat. No. 4,958,224, issued on Sep. 18, 1990, is entitled “Forced correlation/mixed mode tracking system.” It is a tracking system utilizes both a correlation processor and centroid processor to generate track error signals.

Both of these inventions do not adequately solve fundamental control issues (automated autonomous track gate size and position, loss-of-track indication, centroid/correlation track error combining for varied scenario properties) because of the constraints by attempting to solve these problems within the realm of the “Track Process.” Both patents try to solve track control error contributions and the general scenario implementation from a Track Process point of view. These solutions are based upon algorithms utilizing parameters from simply filtered video. A better approach is the TWTE Preprocessor's intelligent filtering of video in order that the Track Process only observes a target in the presented video.

By use of the TWTE Preprocessor of the proposed invention, many or all of these efforts would not be necessary, and the overall application of the resultant system would be much better suited to meet the intended track scenarios. Specifically, the TWTE Preprocessor of the proposed invention attempts to solve these problems by negating the clutter and defining the target prior to the Track Process function. By accomplishing this, the track gate size and position are only necessary for observation and operator designation purposes. They are no longer necessary for track purposes. Any track error contributions are transferred to the TWTE Preprocessor. These errors will be substantially less in this system-wide implementation.

U.S. Pat. No. 4,060,830, issued on Nov. 29, 1977, is entitled “Volumetric balance video tracker.” It is a video tracker for controlling the scanning of a sensor in an electro-optical tracking system in which the track point for the sensor is determined by balancing a volume signal from a first half of the track window with a volume signal from the second half of the track window in both horizontal and vertical directions of the track window to provide azimuth and elevation error signals.

However, the proposed invention is substantially different in that patent '830 is based upon an algorithm that generates track error signals relative to the amount of averaged intensity video within a track gate on either side of a central axis. This invention does little to negate tracking problems with clutter and will most probably not meet the requirements of many track scenarios, especially those that are stressful. On the other hand, integration of the proposed intelligent Tunable Wavelet Track Extraction Preprocessor (TWTEP) dramatically improves target identification, target acquisition and track performance by variably enhancing the video signal and, depending on the stressful scenario, reduce track error and track jitter.

U.S. Pat. No. 5,329,368, entitled “Image tracking system and technique,” issued on Jul. 12, 1994. It is an image motion tracking system for use with an image detector having an array of elements in the x and y directions. This invention is based upon a Track Process that utilizes a Fast Fourier Transform (FFT), which is a mathematical algorithm that transforms spatial information into the frequency domain. In doing so, a loss of spatial integrity is encountered. This means that the result shows frequency content of the image; however, it is unknown where the frequencies appear in relation to image position. To compensate for this loss of spatial integrity, this invention defines object movement by comparing the phase differences of the image FFTs. It relates this information to relative object image displacement. It then develops track control signals. Because patent '368 is a Track Process algorithm, it does not preprocess the video to rid it of background clutter, noise, or extract a target. Therefore, it can benefit by utilizing the TWTE Preprocessor of the proposed invention.

U.S. Pat. No. 6,650,779, entitled “Method and apparatus for analyzing an image to detect and identify patterns,” issued on Nov. 18, 2003. It relates to a method and apparatus for detecting and classifying patterns and, amongst other things to a method and apparatus which utilizes multi-dimensional wavelet neural networks to detect and classify patterns. Patent '224 involves Fault Detection and Identification (FDI) and is primarily for industry production lines where a product is examined to determine a fault. A two-dimensional image is presented to a processor that uses the Wavelet Transform to develop processed image data and then presents this data to a neural network for pattern matching. The pattern matching determines the presence of a fault in the product. These are cooperative targets without the presence of background clutter. “Target Extraction” is not a primary goal of this invention. Therefore, the TWTE Preprocessor's intended use is very different, namely, for the dramatic improvement of target identification, target acquisition and track performance by variably enhancing the video signal and reducing track error and track jitter.

U.S. Pat. No. 6,574,353, entitled “Video object tracking using a hierarchy of deformable templates” and issued on Jun. 3, 2003, relates to object tracking within a sequence of image frames, and more particularly to methods and apparatus for tracking an object using deformable templates. This invention utilizes a Wavelet Transform to determine an edge boundary of an object within a video image, and uses only the high frequency output of the Wavelet Transform, which is a small portion of the available information. Patent '353 uses a defined object boundary from a template or reference image and then seeks to determine a new position of the object in subsequent images. The key point here, which differentiates this invention from the TWTE Preprocessor of the proposed invention, is that each image is subjected to a process of matching the template image with that in the current image by deforming the template representation (scaling and rotating) to fit that in the current. This is very different than that in the TWTE Preprocessor and is yet another methodology for a Track Processor.

U.S. Pat. No. 5,610,653, entitled “Method and system for automatically tracking a zoomed video image,” issued on Mar. 11, 1997. It is a video method and system for automatically tracking a viewer defined target within a viewer defined window of a video image as the target moves within the video image by selecting a target within a video, producing an identification of the selected target, defining a window within the video, utilizing the identification to automatically maintain the selected target within the window of the video as the selected target shifts within the video, and transmitting the window of the video.

However, the proposed invention is substantially different in that patent '653 does not utilize the Wavelet Transform. This invention's intent is to be used for the content delivery industry, e.g., those that delivers movies, interactive games, or sports events to customers. It is a method for defining the point at which a customer interrupts the reception and once again, begins reception. It is also used to define different perspective points for an object. With multiple views of an object available, the viewer is able to choose a different view at the same point in time. This invention deals more with time synchronization than extracting target information.

U.S. Pat. No. 6,553,071, entitled “Motion compensation coding apparatus using wavelet transformation and method thereof,” issued on Apr. 22, 2003. Patent '071 is a motion compensation coding apparatus using a wavelet transformation and a method thereof are capable of detecting a motion vector with respect to a block having a certain change or a motion in an image from a region having a hierarchical structure based on each frequency band and each sub-frequency band generated by wavelet-transforming an inputted motion picture and effectively coding a motion using the detected motion vector. The motion compensation coding apparatus can include a wavelet transformation unit receiving a video signal and wavelet transforming by regions of different frequency bands based on a hierarchical structure, and a motion compensation unit receiving the wavelet-transformed images and compensating the regions having a certain change or motion in the image.

However, the proposed invention is substantially different in that this invention describes the basis for using a Wavelet Transform to compress, transmit, receive, and decompress video information over a communication network. It is another coding scheme utilized to lessen the amount of data (time) needed to transmit/receive video information. It is compared to the older Discrete Cosine Transform (DCT) method. All these methods have been reviewed and standardized by the Motion Picture Expert Group (MPEG).

Though this invention and the TWTE Preprocessor both utilize the Wavelet Transform, this is the only point of commonality. Other critical points of the TWTE Preprocessor of the proposed invention, e.g., Target Extraction and video processing, are not part of the '071 patent.

U.S. Pat. No. 6,542,619, entitled “Method for analyzing video,” issued on Apr. 1, 2003. It is a method and system for recognizing scene changes in digitized video based on using one-dimensional projections from the recorded video. Wavelet transformation is applied on each projection to determine the high frequency components. These components are then auto-correlated and a time-based curve of the autocorrelation coefficients is generated.

However, the proposed invention is substantially different in that this invention is a simple implementation of a Wavelet Transform where only the high frequencies are utilized. They are auto-correlated with a resultant power spectrum. The end result is a kind of description of the video. This process continues on a frame-by-frame basis. If the auto-correlation calculation result is significantly different from the previous image, scene change detection is defined for user notification. Significantly, and unlike the proposed invention, not all Wavelet Transform information is used. There is no extraction of target information, and there is no detection of movement within a frame.

U.S. Pat. No. 6,473,525, entitled “Method for detecting an image edge within a dithered image,” issued on Oct. 29, 2002. It is a method for detecting an image edge within a dithered image. More specifically, patent '525 relates to inverse dithering, and more particularly, to a method for detecting an image edge within a windowed portion of a dithered image. A variety of methods have been developed for performing inverse dithering, including using information generated by a wavelet decomposition to perform the inverse dithering process.

However, the proposed invention is substantially different than the proposed invention. Dithered images are those that utilize a surrounding pixel to “trick” the human eye into believing a color is present that the display is not capable of producing. For example, in the case of a black and white display, there is no gray color. Each pixel is either white or black. However, if two pixels are physically close enough, the human eye cannot resolve their positions. Should one of the pixels be white and the other black, the human eye will integrate the colors and believe them to be gray at the one singular position. This invention draws upon a technique to identify edges (gradients) in the image where dithering has occurred. Significantly, this invention does not extract information or modify the video, as is the case of the TWTE Preprocessor of the proposed invention.

U.S. Pat. No. 6,400,846, entitled “Method for ordering image spaces to search for object surfaces,” issued on Jun. 4, 2002. This invention “segments” video, in conjunction with the MPEG-4 standard, to define properties of objects within a video scene. As one of many possibilities, this invention utilizes the Wavelet Transform to accomplish this. This invention starts with a known object to identify; not an arbitrary object that is extracted. The technique of this invention involves the defining of objects and properties of these objects within the video image such that the object can be “lifted” from the video and be used as a standalone object to be “pasted” into another video scene, for example.

The key to the differences here is that the techniques employed in patent '846 begin with prior knowledge of the object to be tracked. The TWTE Preprocessor of the proposed invention does not make such an assumption. Also, the algorithm of patent '846 depends upon multiple frames of video images, whereas the TWTE Preprocessor does not.

U.S. Pat. No. 6,005,609, entitled “Method and apparatus for digital correlation object tracker using a shape extraction focalization technique,” issued on Dec. 21, 1999. Patent '609 relates to target tracking and apparatus, and particularly to a method and apparatus for controlling a picture-taking device to track a moving object by utilizing a calculation of a correlation between a correlation area extracted from a former image and a checking area extracted from a current area.

The functionality of this invention is close to the entire system approach of a proposed tracking system that would utilize the TWTE Preprocessor of the proposed invention. However, there are critical important differences. 1) The algorithm does not modify the video to improve tracking. 2) The algorithm within patent '609 does not utilize the Wavelet Transform, which would otherwise immunity to background noise. (It utilizes a simple differentiator, which does not utilize all the information available in the video scene). 3) The TWTE Preprocessor of the proposed invention has two main components: i) Target Extraction, and ii) Video Enhancement. Though Target Extraction of patent '609 and the proposed invention have the same functionality, the methodology is different: The TWTE Preprocessor of the proposed invention uses all the information in the video scene to determine the target shape for extraction. In addition, the Video Enhancement functionality is unique to the TWTE Preprocessor and enhances the algorithm's ability to accomplish the Target Extraction function. Taken together, the TWTE Preprocessor of the proposed invention is a very significant improvement over this invention.

U.S. Pat. No. 5,947,413, entitled “Correlation filters for target reacquisition in trackers,” issued on Sep. 7, 1999. It is a system and method for target reacquisition and aimpoint selection in missile trackers, i.e., patent '413 relates to a method for tracking the position of a target in a sequence of image frames provided by a sensor, comprising a sequence of steps.

However, the proposed invention is substantially different in that patent '413 does not utilize the Wavelet Transform and relies upon predetermined knowledge of the target. Patent '413 has more to do with tracking rather than video processing and, as such, has little to do with the functionality of the TWTE Preprocessor of the proposed invention, namely, target extraction and video enhancement.

U.S. Pat. No. 5,422,828, entitled “Method and system for image-sequence-based target tracking and range estimation” and issued on Jun. 6, 1995, relates to electronic sensing methods and systems, and more particularly to a method and system for image-sequence-based target tracking and range estimation that tracks objects across a sequence of images to estimate the range to the tracked objects from an imaging camera.

However, the proposed invention is substantially different in that Patent '828 does not utilize the Wavelet Transform, and has little to do with the functionality of the TWTE Preprocessor of the proposed invention. Also, patent '828 is primarily concerned with estimating range to the target in a passive manner and is concerned with tracking only as a means to this end. As such, patent '828 has little to do with the functionality of the TWTE Preprocessor of the proposed invention, namely, target extraction and video enhancement.

U.S. Pat. No. 4,937,878, entitled “Signal processing for autonomous acquisition of objects in cluttered background,” issued on Jun. 26, 1990. It is a method and apparatus for detecting moving objects silhouetted against background clutter. A correlation subsystem is used to register the background of a current image frame with an image frame taken two time periods earlier.

Patent '878 relates to image processing techniques and, more particularly, to techniques for detecting objects moving through cluttered background. However, patent '878 does not utilize the Wavelet Transform but is a simple attempt to define the background clutter and negate it. It basically takes three snapshot images (A, B, C) with a target and background. It is assumed that the background is constant and the target is moving. These assumptions are correct many times; however, for the “stressful” scenario—of which the proposed invention directly addresses and solves, relative motion between the background and the target will be very small. This will certainly create a target acquisition problem for patent '878. Also, the actual resultant image, for tracking purposes, has not enhanced the target within the video or negated all noise. This will result in residual artifacts. These problems are directly addressed and resolved by the proposed invention.

U.S. Pat. No. 4,739,401, entitled “Target acquisition system and method,” issued on Apr. 19, 1988. Patent '401 relates generally to image processing systems and methods, and more particularly to image processing systems and methods for identifying and tracking target objects located within an image scene. However, patent '401 does not utilize the Wavelet Transform. Also, patent '401 depends upon spatial filtering and a filter for target size. It then depends upon a “feature” determination process to identify targets to be tracked by matching these features with a database of known target features. Also, it depends upon “gates” (selected areas within the image) to define target location. All these methods are either time consuming, inefficient, not reliable, depend upon operator intervention, or require prior knowledge of targets and all parameters that can influence the target appearance. Any or all of these deficiencies render this invention not practical and most probably incapable of accomplishing many tracking scenarios. These deficiencies are not present in the proposed invention.

U.S. Pat. No. 4,671,650, entitled “Apparatus and method for determining aircraft position and velocity” and issued on Jun. 9, 1987, relates to an apparatus and method for determining aircraft velocity and position, and more particularly, to an apparatus and method for determining the longitudinal and lateral ground velocity of an aircraft and for providing positional data for navigation of the aircraft. However, patent '650 does not utilize the Wavelet Transform, and depends upon a means of having two cameras looking at a target from different angles to determine the targets velocity, speed, etc. It is a complicated system that depends upon much working together to accomplish the task. It does not enhance video or negate background clutter. Without very constrained requirements and coordination among cooperative systems, it is not designed to provide the accuracy, timeliness, and simplicity for the intended applications of the TWTE Preprocessor of the proposed invention and associated track functions.

U.S. Pat. No. 6,353,634, entitled “Video decoder using bi-orthogonal wavelet coding” and issued on Mar. 5, 2002, relates to video signal decoding systems, and more particularly, with a digital decoding system for decoding video signals which uses bi-orthogonal wavelet coding to decompress digitized video data. This invention “merely” receives Wavelet compressed video data from a serial communication link, decompresses it, and displays an image on a display. Patent '634 is not designed to provide the accuracy, timeliness, and simplicity for the intended applications of the TWTE Preprocessor of the proposed invention and associated track functions.

U.S. Pat. No. 6,445,832, entitled “Balanced template tracker for tracking an object image sequence,” issued on Sep. 3, 2002. It is a method and apparatus are described for tracking an object image in an image sequence in which a template window associated with the object image is established from a first image in the image sequence and an edge gradient direction extracted. Specifically, rather than correlate on targets within the image, this invention's technique is to detect the edge of a target within an image and correlate the edge(s) on a frame-by-frame basis. This is nothing new. The added feature is that the algorithm allows for the possibility of weighting the edges in the correlation calculation. The algorithm may give equal or unequal weight to different detected edges within the image to influence the correlation result. For example, if it is determined that the leading edge of a target is more stable than a different edge within the image, a higher weight may be placed upon that edge resulting a more stable track.

Patent '832 does not utilize the Wavelet Transform or take advantage of all information within the image. It does not negate clutter or enhance the video to be tracked. As such, it is not designed to provide the accuracy, timeliness, and simplicity for the intended applications of the TWTE Preprocessor of the proposed invention and associated track functions.

U.S. Pat. No. 6,292,592, entitled “Efficient multi-resolution space-time adaptive processor,” issued on Sep. 18, 2001. It is an image processing system and method. In accordance with the inventive method, adapted for use in an illustrative image processing application, a first composite input signal is provided based on plurality of data values output from a sensor in response to a scene including a target and clutter.

Although there are similarities of this patent with the proposed TWTE Preprocessor, there are substantial and fundamental differences in methodology and functionality. Specifically, the TWTE Preprocessor of the proposed invention 1) Enhances and augments the target within the video scene to provide a better tracking source for the externally provided Track Process, 2) Implements a tunable target definition from the video image to provide a highly resolved target delineation and selection, and 3) Utilizes a weighted pseudo-covariance technique to define target area for shape determination, extraction, and further processing. This is not implemented in the '592 invention (Though this functionality is shown in the block diagram of the '592 invention, it is merely declared as an input, “Cueing System,” to a filtering process).

The '592 invention is mainly concerned with the technique of filtering background clutter and unwanted targets (undefined) from the video scene. While the TWTE Preprocessor of the proposed invention accomplishes this, the proposed invention's main thrusts also include target definition/selection and system track performance improvement. The '592 invention strives to only provide a target to track without regard for improvement of system track performance. Due to the lack of some or all of these traits and the lack of Cueing System definition in the '592 invention, it would be difficult for the '592 invention to perform in the stressful scenario.

FIG. 16 is a table that compares the significant functional differences between the '592 patent and the proposed TWTE Preprocessor.

U.S. Pat. No. 6,122,405, entitled “Adaptive filter selection for optimal feature extraction,” issued on Sep. 19, 2000. It is a method for analyzing a region of interest in an original image to extract at least one robust feature, including the steps of passing signals representing the original image through a first filter to obtain signals representing a smoothed image, performing a profile analysis on the signals representing the smoothed image to determine a signal representing a size value for any feature in the original image, performing a cluster analysis on the signals representing the size values determined by the profile analysis to determine a signal representing a most frequently occurring size, selecting an optimal filter based on the determined signal representing the most frequently occurring size, and passing the signals representing the original image through the optimal filter to obtain an optimally filtered image having an optimally high signal-to-noise ratio.

Unlike the proposed invention, patent '405 does not use the Wavelet Transform. Patent '405 is a basic spatial filtering invention that filters objects within the image that are of a determined size, based upon some statistics of the video. There is no effort to enhance or modify the video, and there is no effort to identify or designate a target. As such, it is not designed to provide the accuracy, timeliness, and simplicity for the intended applications of the TWTE Preprocessor of the proposed invention and associated track functions.

U.S. Pat. No. 6,081,753, entitled “Method of determining probability of target detection in a visually cluttered scene,” issued on Jun. 27, 2000. It is a method to determine the probability of detection, P(t), of targets within infrared-imaged, pixelated scenes and includes dividing the scenes into tar blocks and background blocks. Patent '405 does not use the Wavelet Transform, and is another methodology for detecting the presence of a target in the video. There is no effort to enhance or modify the video image. As such, it is not designed to provide the accuracy, timeliness, and simplicity for the intended applications of the TWTE Preprocessor of the proposed invention and associated track functions.

U.S. Pat. No. 5,872,858, entitled “Moving body recognition apparatus” and issued on Feb. 16, 1999, is a moving body recognition apparatus that recognizes a shape and movement of an object moving in relation to an image input unit by extracting feature points, e.g., a peak of the object and a boundary of color, each in said images captured at a plurality of instants in time for observation by the image input unit.

However, the purpose of patent '858, which does not use the Wavelet Transform, is to determine the presence of an object within an image and determine its angular rotations as it moves through space. Multiple images are used in the process. There is no effort to enhance or modify the video. As such, it is not designed to provide the accuracy, timeliness, and simplicity for the intended applications of the TWTE Preprocessor of the proposed invention and associated track functions.

U.S Pat. No. 5,872,857, entitled “Generalized biased centroid edge locator” and issued on Feb. 16, 1999, is an edge locator processor having memory and which employs a generalized biased centroid edge locator process to determining the leading edge of an object in a scene moving in a generally horizontal direction across a video screen.

However, patent '405, which does not use the Wavelet Transform, is an enhancement of current track systems to solve a known scenario issue; patent '405 proposes an automated method for determining an aimpoint (the leading edge of a target, e.g., the nose of a missile). This is an exercise in image processing to aid a tracking system once a stable track has been obtained.

Significantly, there is no effort to enhance or modify the video, and no effort to identify a target. As such, it is not designed to provide the accuracy, timeliness, and simplicity for the intended applications of the TWTE Preprocessor of the proposed invention and associated track functions.

U.S. Pat. No. 5,842,156, entitled “Multirate multiresolution target tracking” and issued on Nov. 24, 1998, is a multi-resolution, multi-rate approach for detecting and following targets. The resolution of data obtained from a target scanning region is reduced spatially and temporally in order to provide to a tracker a reduced amount of data to calculate. This invention is meant to track the course of multiple targets while minimizing the required computing power. It involves the coordination of multiple aircraft tracking systems working in collaboration. It utilizes target course information and is not concerned with the actual act of tracking, only the resultant. As such, there is no effort to enhance or modify the video and no effort to identify or designate a target. Therefore, it is not designed to provide the accuracy, timeliness, and simplicity for the intended applications of the TWTE Preprocessor of the proposed invention and associated track functions.

U.S. Pat. No. 6,571,117, entitled “Capillary sweet spot imaging for improving the tracking accuracy and SNR of noninvasive blood analysis methods,” issued on May 27, 2003. It relates to methods and apparatuses for improving the tracking accuracy and signal-to-noise ratio of noninvasive blood analysis methods. However, patent '117, which does not use the Wavelet Transform, attempts to increase the Signal-to-Noise Ratio (SNR) of concentrated blood capillaries by choosing by analyzing images from a camera scene illuminated with a known frequency of light. By finding these highly concentrated areas, the conclusions about blood chemistry can be better correlated to the actual blood within the body, as opposed to just the sample being examined. As such, there is no effort to enhance or modify the video and no effort to identify or designate a target. Therefore, it is not designed to provide the accuracy, timeliness, and simplicity for the intended applications of the TWTE Preprocessor of the proposed invention and associated track functions.

U.S. Pat. No. 5,414,780, entitled “Method and apparatus for image data transformation,” issued on May 9, 1995. Patent '780 relates to methods and apparatus for transforming image data (such as video data) for subsequent quantization, motion estimation, and/or coding. More particularly, the invention pertains to recursive interleaving of image data to generate blocks of component image coefficients having form suitable for subsequent quantization, motion estimation, and/or coding.

Patent '780 is a hardware implementation of the Wavelet Transform accomplished in real time. As such, there is no effort to enhance or modify the video and no effort to identify or designate a target. Therefore, it is not designed to provide the accuracy, timeliness, and simplicity for the intended applications of the TWTE Preprocessor of the proposed invention and associated track functions.

U.S. Pat. No. 6,625,217, entitled “Constrained wavelet packet for tree-structured video coders,” issued on Sep. 23, 2003. It is a method for optimizing a wavelet packet structure for subsequent tree-structured coding which preserves coherent spatial relationships between parent coefficients and their respective four offspring at each step. Patent '217 relates to image and video coding and decoding and more particularly, to a method for optimizing a wavelet packet structure for subsequent tree-structured coding.

As such, there is no effort to enhance or modify the video and no effort to identify or designate a target. Therefore, it is not designed to provide the accuracy, timeliness, and simplicity for the intended applications of the TWTE Preprocessor of the proposed invention and associated track functions.

U.S. Pat. No. 6,292,683, entitled “Method and apparatus for tracking motion in MR images” and issued on Sep. 18, 2001, relates to magnetic resonance imaging (MRI) and includes a method and apparatus to track motion of anatomy or medical instruments, for example, between MR images. However, patent '683, which does not use the Wavelet Transform, computes a correlation between images to determine movement of a reference within the scene. As such, there is no effort to enhance or modify the video and no effort to identify or designate a target. Therefore, it is not designed to provide the accuracy, timeliness, and simplicity for the intended applications of the TWTE Preprocessor of the proposed invention and associated track functions.

### SUMMARY OF THE INVENTION

The need in the art is directly addressed by the TWTE Preprocessor of the present invention. In accordance with the inventive method, it is an object of the present invention to provide a novel target tracking system with a substantially improved track performance with targets under stressful conditions.

It is another object of the present invention (TWTE Preprocessor) to provide a given target tracking system with the ability to accurately determine target characteristics, e.g., boundary and shape, based on a set of known or unknown conditions, in the presence of high noise and clutter.

It is another object of the present invention (TWTE Preprocessor) to pre-process a target within a video scene into a substantially higher definition target to allow a given target tracking system to acquire the target quicker and with greater success under stressful conditions, e.g., low target Signal-to-Noise Ratio (SNR), low target Signal-to-Clutter Ratio (SCR), little relative motion between target and background, non-maskable target induced clutter (target exhaust gasses or plumes), and/or small target area.

It is another object of the present invention (TWTE Preprocessor) to enhance the probability of accurately defining a target within a video scene.

It is another object of the present invention (TWTE Preprocessor) to aid a given target tracking system in target identification with a higher probability of success.

It is another object of the present invention (TWTE Preprocessor) to obviate time lag and its associated problems, as there is no successive video field memory required in the TWTE Preprocessor algorithms.

It is another object of the present invention (TWTE Preprocessor) to be able to operate in either of two different modes of operation, namely, Direct Video Mode and Covariant Recomposition Video Mode, each with its own set of advantages.

It is another object of the present invention (TWTE Preprocessor) to produce a Sub-Band result that maintains spatial and temporal integrity, which is a major differentiator of performance from other signal processing techniques. (The Wavelet Sub-Band Processing accomplishes the spatial and temporal filtering of objects (target and clutter) within the video field (frame). Each Sub-Band is capable of independent filtering.)

It is another object of the present invention (TWTE Preprocessor) to provide other potential advantages important to tracking different types of targets under varying scenarios, including i) “plume” negation; ii) target identification, iii) target orientation/direction bearing, iv) target feature extraction, v) temporal filtering, vi) spatial filtering, and vii) spectral filtering.

### BRIEF DESCRIPTION OF THE DRAWINGS

The present invention broadly relates to a new and vastly improved target tracking system for various system applications, and includes substantially more accurate target definition, target selection, target acquisition and track performance.

FIG. 1 is a simplified Block Diagram of the seven sub-functions of the TWTE Preprocessor, namely, the a) Sensor Input Processing, b) Wavelet Transform Processing, c) Wavelet Sub-Band Processing, d) Pseudo-Covariance Processing, e) Target Definition/Enhancement Processing, f) Video Output Processing, and g) Control/Status Processing.

FIG. 2. At the expense of additional processing, this algorithm results in a Wavelet-filtered approach to generation of track video rather than producing a region of raw or simulated video as in the Direct Video Mode. These algorithms are summarized in this Figure. Major points of difference are shown in bold.

FIG. 3. The detailed Sensor Input Processing.

FIG. 4. The detailed Wavelet Transform Processing.

FIG. 5 illustrates the relationship between a presumed target and high frequency noise. After Wavelet Transform Processing, the resultant Wavelet Sub-Bands are produced, each decimated by a power of 2 in resolution in each axis. (In this illustration, both axes are depicted). Noise is generally high frequency in nature, as well as blob edges (gradient intensities within the image). Uniform intensity targets are low frequency video blobs (uniform intensities within the image). Progressively, as the illustration suggests, the blobs of the video scene are readily apparent in the Low Order Sub-bands, while the gradients are more prevalent in the High Order Sub-Bands. Again, most significant is that the definition of video information remains in terms of spatial (and temporal) integrity. The Wavelet Sub-Bands provide a separation in video characteristic, whether it is target or background.

FIG. 6. The detailed Wavelet Sub-Band Processing.

FIG. 7. The detailed Pseudo-Covariance Processing.

FIG. 8. Common to both modes of operation is a process termed a “pseudo-covariance.” It is a variation on the statistical covariance computation. A statistical covariance is a measure of the variability of one variable with regards to another. A covariance calculation results in a number between −1 and 1. A −1 signifies a full negative variability (a variable changes in the opposite polarity of another variable), a 1 indicates a full positive variability (a variable changes in the same polarity of another variable), while a 0 indicates that no statistical relation exists between the variables. A covariance between −1 and 0, 0 and 1 indicate degrees of statistical covariance. The TWTE Preprocessor calculates pixel covariance degrees between any Wavelet filtered Sub-Bands. Because this algorithm attempts to measure the existence of any covariance within all Sub-Bands (more than two variables), it has been termed a “pseudo-covariance.”

FIG. 9 (not to scale). Due to the decimation by two of Wavelet array size (rows and columns) as the Wavelet Transform products undergo successive filtering (edges to blobs), each Sub-Band must be “expanded” by the equal power of two to maintain consistent scale (size) for further processing. That is, all Wavelet Sub-Band arrays must have the same number of rows and columns. This required expansion is accomplished for each Sub-Band by duplicating row and column entries the appropriate power of two numbers of times. This process maintains spatial consistencies over the Wavelet Sub-Bands.

FIG. 10. Covariance Recomposition Video Mode of Operation: As stated earlier, this mode of operation performs the Pseudo-covariance computation as in the Direct Video Mode. In addition, other processing is accomplished in order to produce a video array of filtered Wavelet video. The array is the result of an Inverse Wavelet Transform Computation operating on filtered Wavelet Sub-Band information.

FIG. 11. The Wavelet Sub-Band Coefficient Filtering is followed by the Wavelet Sub-Band Covariance Filtering process. For each Covariance Sub-Band pair computation, pixels of associated Sub-Band elements are multiplied by the pixel covariance coefficient and summed with previous computations of other covariance Sub-Band pairs. This process produces a Wavelet Sub-Band set that is then Inverse Wavelet Transformed. The result is an image that has been recomposed from filtered imagery.

In this figure, the conceptual resultant video depicts a well-defined target and vastly reduced background clutter and noise. Though this is not illustrated, dependent upon target and background characteristics, all background clutter and noise could be totally negated. With greater SNR and non-competing potential target objects, this would achieve significantly improved track performance.

FIG. 12. The detailed Target Definition/Enhancement Processing.

FIG. 13. The detailed Video Output Processing.

FIG. 14. The Detailed TWTE Preprocessor Block Diagram.

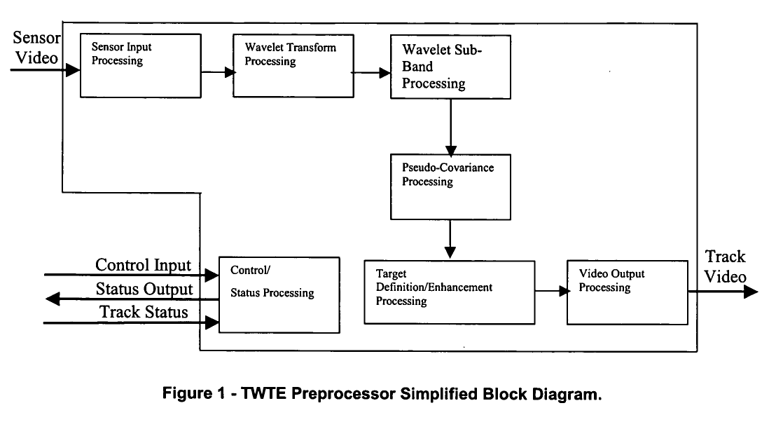

### DETAILED DESCRIPTION OF THE PREFERRED EMBODIMENT

The TWTE Preprocessor of the present invention is composed of seven (7) subfunctions, all explained in detail below:
a) Control/Status Processing
b) Sensor Input Processing
c) Wavelet Transform Processing
d) Wavelet Sub-Band Processing
e) Pseudo-Covariance Processing
f) Target Definition/Enhancement Processing
g) Video Output Processing

A simplified Block Diagram is shown in FIG. 15. These subfunctions interface to provide the total functionality of the TWTE Preprocessor. Externally, the TWTE Preprocessor interfaces to a Sensor, a Track Processor, and a manual or automatic control process.

All or any of the functions depicted in the Simplified Block Diagram may be implemented in hardware, software, or firmware, dependent upon scenario, speed, cost, and physical requirements.

Modes of Operation:

The TWTE Preprocessor is capable of two modes of operation: Direct Video Mode and Covariant Recomposition Video Mode. Both modes operate within the same TWTE Preprocessor Subfunctions and architecture. However, for a given operational mode, the Pseudo-Covariance Processing and the Video Output Processing implement different algorithmic paths. A summary of the algorithmic processing and inherent performance advantages for each mode is described here and in detail within the Subfunction descriptions.

In the Direct Video Mode, possible target regions are determined by a Pseudo-Covariance method. This method defines regions of interest within the video based upon a covariance between Wavelet Sub-bands. It then makes a determination of the target region and uses the sensor or simulated video for output to the Track Process.

In the Covariant Recomposition Video Mode, target regions are determined as in the Direct Video Mode. Based upon target Wavelet Sub-Band filtered characteristic coefficients and the degree of covariance between each combination of Wavelet Sub-Bands, a set of Wavelet Sub-Bands is generated, which contains elements representing covariance weighed Wavelet Sub-Band information. That is, the resultant arrays represent the original filtered video scene in Wavelet transformed space. Target definition processing proceeds and the video output to the Track Process is a result of an Inverse Wavelet Transform. In this manner, the video output to the Track Process is not the original or simulated video, but rather a product of the covariance weighted Wavelet Sub-Bands. It is a “recomposition” of the filtered sensor video via an Inverse Wavelet Transform.

It is understood that valid targets exhibit filterable identifiable characteristics in different Wavelet Sub-Bands, and that a priori target characteristic knowledge and/or a pixel covariance of Wavelet Sub-Bands is a valid measure of significant information.

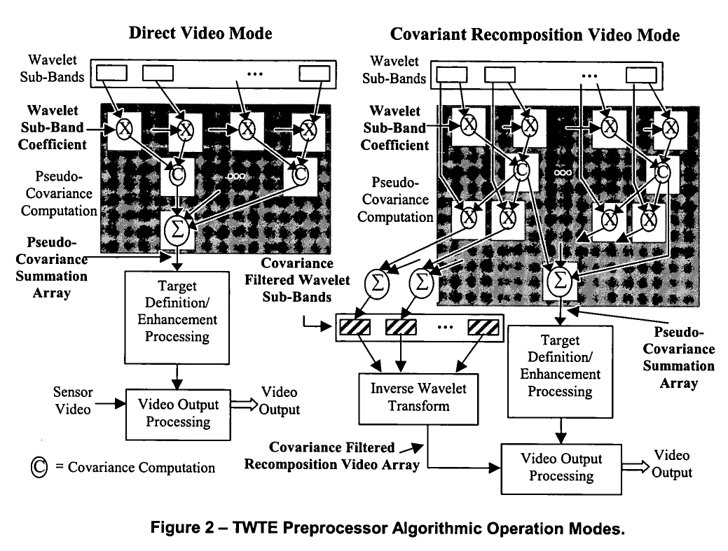

At the expense of additional processing, this algorithm results in a Wavelet-filtered approach to generation of track video rather than producing a region of raw or simulated video as in the Direct Video Mode. These algorithms are summarized in FIG. 2. Major points of difference are shown in bold.

TWTE Preprocessor Subfunctions

a) Control/Status Processing:

While not an algorithmic function of the TWTE Preprocessor, the Control/Status Processing is essential to the implementation. It manages each of the algorithmic functions and provides an interface to the external control and status. It is this processing that orchestrates the flow and configuration of each of the other subfunctions to accomplish the overall affectivity of the unit.

For advanced tracking techniques, it receives a track status indication from the Track Processor. Given the derived track error or Track Processor parameter(s) signifying the degree of track quality, the TWTE Preprocessor is capable of modifying the Track Process sensor video to optimize the overall system performance in a closed-loop technique.

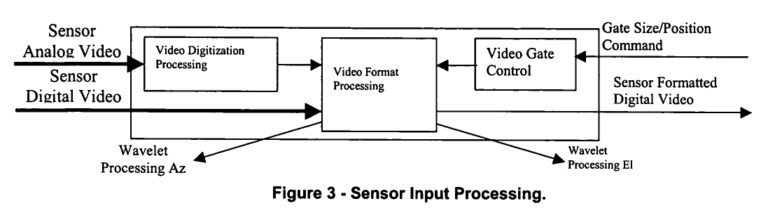

b) Sensor Input Processing (see FIG. 3):

Video from an external video sensor signal is applied. The video signal is either an analog or a digital format video signal. Sensor Analog Video is first digitized to facilitate further processing in the digital domain, or Sensor Digital Video is directly passed to a video formatting process.

Because there are many video standards, it is necessary to convert the sensor video to a consistent or standard format that is suitable for the follow-on processing within the TWTE Preprocessor. This format is dictated by the inherent properties of the Wavelet Transform. Each video row and column must consist of pixel data points numbering a power of 2 (2^{P}, where p=0, 1, 2, . . . ). P is limited by the amount of data points to be processed by the Wavelet Transform and the resolution of the sensor. P may take on different values for the Azimuth and Elevation axes. Should the Sensor Digital Video not have a resolution of a power of 2, pixel data points, having a value of zero, may be added (zero padding) to produce the appropriate number of data points. Other standard signal processing techniques also exist to mitigate the potential problem of a number of data points not equal to a power of 2.

In terms of follow-on TWTE Preprocessor computational requirements, an entire video image may pose a formidable task in terms of the amount of data to be processed. For many implementations, it is still reasonable to expect processing power utilized in state-of-the-art systems to be sufficient. However, under most circumstances, it is possible and reasonable to lessen the processing requirement by “gating” the amount of observed video. A gate (usually rectangular, but not necessarily) may be superimposed over a region of the video image to designate an area of interest. All outlying regions are not processed. In this way the amount of data points to undergo further processing, relative to the power of 2 restrictions, will be minimized.

Another means to lessen the processing demand is to operate the TWTE Preprocessor and the remainder of the system at less than full video field (frame) rate. In cost efficient implementations, a means of throttling the system video field (frame) rate can be dynamically traded with gate size and required resolution during the different phases of system operation in order to control the data processing requirement of the TWTE Preprocessor. For example, for targets of low motion (or once a relatively stable track has been attained) within the video frame, the gate size may be small; however, during an Acquisition Phase, the mission requirement may call for a large gate with low resolution. A dynamic algorithm could be defined to control the processing requirement of the TWTE Preprocessor to within scenario driven bounds.

There are three internal outputs of the Sensor Video Processing:
Wavelet Transform Processing Az (Azimuth),
Wavelet Transform Processing El (Elevation), and
Sensor Formatted Digital Video. The Sensor Formatted Digital Video is sent to the Wavelet Transform Processing in both axes. The same digitized video is output to the Video Output Processing Subfunction to possibly be included, or portions mixed, with the video output for tracking or monitoring.

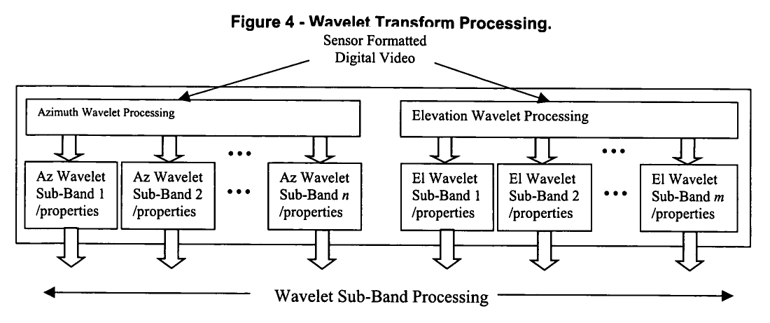

c) Wavelet Transform Processing (see FIG. 4):

The Wavelet Transform Processing consists of performing a Wavelet Transform on the Sensor Formatted Digital Video. A one-dimensional Wavelet Transform is accomplished for each row and column of video. There are many possible Wavelet Transforms that could be implemented, as there are many Wavelet algorithms, each with its own “basis” Wavelet and degree of Wavelet coefficients. The optimal choice of Wavelet algorithm is dependent upon scenario and target parameters. The result of the Wavelet algorithm processing in each axis is an array of data representing Wavelet filtered video pixels for each Wavelet Sub-Band. Inherent in the Wavelet Transform algorithm for each axis is that each successive Wavelet Sub-band is decimated in resolution (number of pixel elements) by a power of 2. The Sub-Bands with a low number of data points are discarded, as the resolution is too coarse to be useful.

Each useful array, corresponding to a Wavelet Sub-Band, represents useful information relative to the characteristics of all information (target and background clutter) within the video field (frame). While this information cannot be described as a “Frequency Spectrum” characteristic for each Wavelet Sub-Band, the analogy of a spectrum holds. Most significant is the fact that the Wavelet Transform produces a Sub-Band result that maintains spatial and temporal integrity. This characteristic of the Wavelet Transform is a major differentiator of performance from other signal processing techniques.

As it pertains to this invention, the results of the Wavelet Transform Processing will be a number of Wavelet Sub-Bands in each axis. The Higher Order Sub-Bands will emphasize gradients within the video, while the lower order Sub-Bands will emphasize “blobs” within the video. Intermediate Sub-Bands will be progressively illustrative of each of these video characteristics, dependent upon their order.

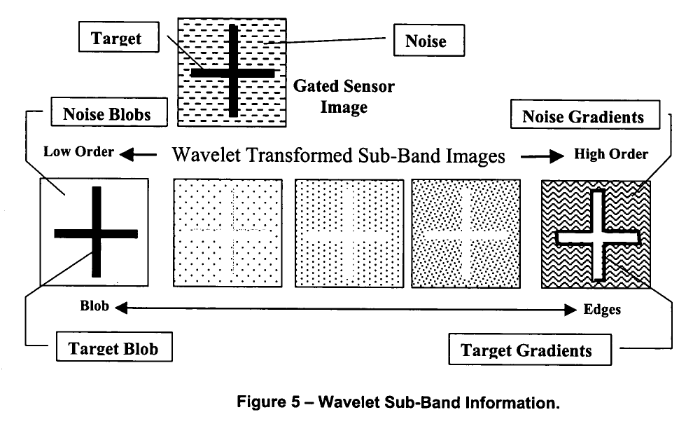

FIG. 5 illustrates the relationship. A presumed target and high frequency noise are shown. After Wavelet Transform Processing pursuant to the proposed invention, the resultant Wavelet Sub-Bands are produced, each decimated by a power of 2 in resolution in each axis. (In this illustration, both axes are depicted). Noise is generally high frequency in nature, as well as blob edges (gradient intensities within the image). Uniform intensity targets are low frequency video blobs (uniform intensities within the image). Progressively, as illustrated, the blobs of the video scene are readily apparent in the Low Order Sub-bands, while the gradients are more prevalent in the High Order Sub-Bands. Again, most significant is that the definition of video information remains in terms of spatial (and temporal) integrity. The Wavelet Sub-Bands provide a separation in video characteristic, whether it is target or background.

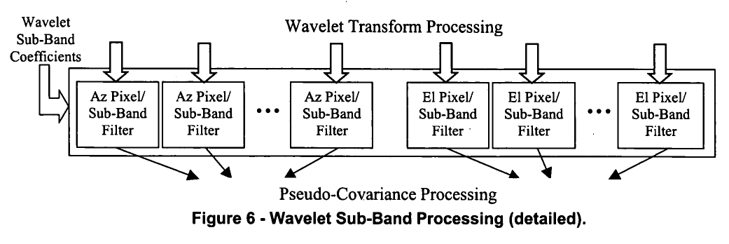

d) Wavelet Sub-Band Processing (see FIG. 6):

The Wavelet Sub-Band Processing accomplishes the spatial and temporal filtering of objects (target and clutter) within the video field (frame). Each Sub-Band is capable of independent filtering. That is, each Sub-Band is capable of spatial and/or temporal filtering with different parameters. This is useful because targets and noise (clutter) are defined differently in each Sub-Band. In fact, the characteristics of a given Sub-Band will help in definition of the filtering parameters for other Sub-Bands. In addition, each Sub-Band's values can be multiplied by a defined/determined Sub-Band Coefficient. This coefficient serves to emphasize or reduce the influence of information within each of the Sub-Bands, as appropriate.

Spatial filtering can either enhance or negate objects based upon their area or shape. Temporal filtering can either enhance or negate objects based upon their time of observance. Spatial filtering and temporal filtering may be used in any order. Enhancement may be accomplished by amplifying the intensity of filter-determined regions of pixels while negation may be accomplished by lessening the intensity of the same pixels within each Sub-Band. The field (frame) rate at which this filtering is accomplished may be specified as immediate or over a period of time.

This Sub-Band Processing capability is very useful in a variety of scenarios. In this manner, transient objects or those that are highly stationary may be detected or negated. As an example, while tracking a military aircraft, launch of a missile might be detected via this mechanism should the scenario call for this, and the original aircraft negated from the Track Processor video output. With the coordination of an external Mission Control Function in a system, the Track Processor could be commanded to begin a new correlation track, resulting in an acquisition and track of the missile. Or, if directed, the missile might just as easily be detected and negated within the video in order to maintain track of the aircraft.

An additional example is that of tracking a target with a plume (hot exhaust gasses from a jet engine) with an infrared video sensor. Typically, plumes have a steady “hot” central core with transient “hot” video emanations. The core will tend to be transformed as time-invariant blobs while the transient emanations will transform as constantly changing gradients, limited in area. The transient effect may hinder the attainment of a stable track of the target. The spatial and temporal filtering will aid, as a first order attempt, to negate these detrimental aberrations. Follow-on processing within the TWTE Preprocessor will further negate remaining problems caused by plume characteristics.

Also, a first order filtering of electronic induced noise within the video may be accomplished. Further filtering is accomplished in follow-on processing.

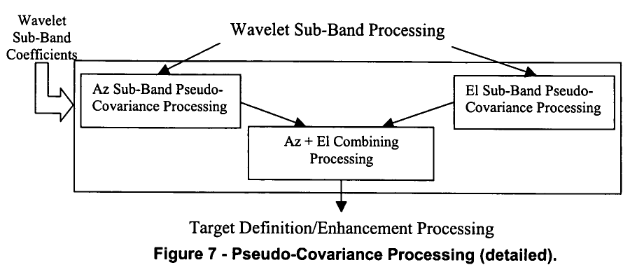

e) Pseudo-Covariance Processing (see FIG. 7):

This subfunction has two modes of operation:
Direct Video Mode—responsible for computing a “pseudo-covariance” of all Wavelet filtered Sub-Bands in both axes. It then combines the resultant into a singular array.
Covariance Recomposition Video Mode—this subfunction has two outputs: i) a resultant Pseudo-Covariance array, as before, and ii) a Covariance Filtered Recomposition Video Array. The Direct Video Mode optionally presents raw sensor video to the Video Output Processing; while, the Covariance Recomposition Video Mode presents a Wavelet filtered video signal.
   Direct Video Mode of Operation:

Common to both modes of operation is a process termed a “pseudo-covariance.” It is a variation on the statistical covariance computation. A statistical covariance is a measure of the variability of one variable relative to another. A covariance calculation results in a number between −1 and +1. A value of −1 signifies a full negative variability (a variable changes in the opposite polarity of another variable). A value of +1 indicates a full positive variability a variable changes in the same polarity of another variable). A value of 0 indicates that no statistical relation exists between the variables.

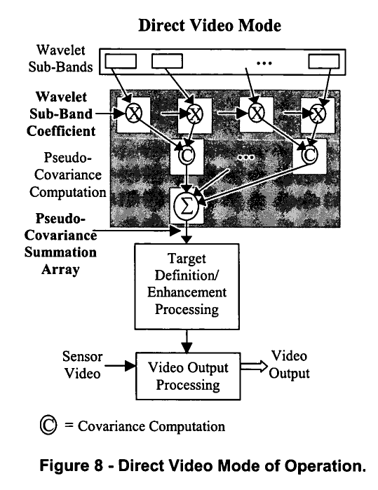

A covariance value other than 0, i.e., between −1 and 0 or 0 and +1 indicates degrees of statistical covariance. The TWTE Preprocessor calculates pixel covariance degrees between any Wavelet filtered Sub-Bands. Because this algorithm attempts to measure the existence of any covariance within all Sub-Bands (more than two variables), it has been termed a “pseudo-covariance.” The process is illustrated in FIG. 8.

One of the foundations of the TWTE Preprocessor is that there is a significant covariant relationship between any two or more Wavelet filtered Sub-Bands that signifies a target within a video field (frame). This is based upon the understanding that a valid target, in Wavelet product terms, is typically decomposable into multiple Wavelet Sub-Bands (edges to blobs). Due to the Spatial and temporal integrity nature of the Wavelet algorithm, a statistically significant degree of covariance will exist for pixel locations where valid targets exist. Where there is no target, i.e., all noise, the pseudo-covariance will be close to 0. Background objects will also posses this same significant property.

The objective of this processing is to identify pixel locations where possible targets exist. A grouping of these pixels into possible target regions and choice of region as the target is accomplished in the Target Definition/Enhancement Processing, described below.

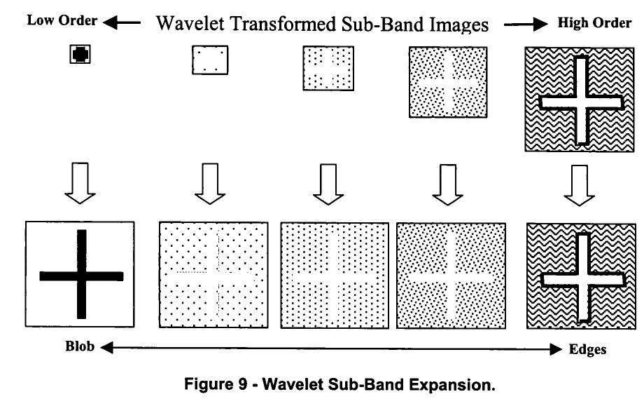

Due to the decimation by two of Wavelet array size (rows and columns) as the Wavelet Transform products undergo successive filtering (edges to blobs), each Sub-Band must be “expanded” by the equal power of two to maintain consistent scale (size) for further processing. That is, all Wavelet Sub-Band arrays must have the same number of rows and columns. This required expansion is accomplished for each Sub-Band by duplicating row and column entries the appropriate power of two number of times. This process maintains spatial consistencies over the Wavelet Sub-Bands. This is illustrated, not to scale, in FIG. 9.

For all unique combinations of Sub-Bands taken two at a time, a Sub-Band Pixel Covariance array is calculated as is defined in
Sub-Band Covariance[i, j]=|SBCₐ*pₐ[i, j]*SBC_{b}*p_{b}[i, j]|; a±b Equation 2
Where: Sub-Band Covariance[i, j]=Covariance of Sub-Bandₐ and Sub-Band_{b} at array location [i, j],
   i=Sub-Band array row,
   j=Sub-Band array column,
   a (b)=1 . . . n; n is the number of useable Sub-Bands for a given axis,
   SBCₐ, SBC_{b}=Sub-Band a, b Coefficient,
   pₐ[i, j], p_{b}[i, j]=Pixel intensity at location [i, j] of Sub-Band a, b,
         | |=Absolute Value function
      Note that an absolute value is calculated, as there is no need to differentiate polarity of covariance.

The Axis Pseudo-Covariance is now computed by summing all of the Sub-Band Covariance arrays resulting in a single array. Both Axis Pseudo-Covariance arrays are then summed producing the Pseudo-Covariance array of the video field (frame).

Covariance Recomposition Video Mode of Operation:

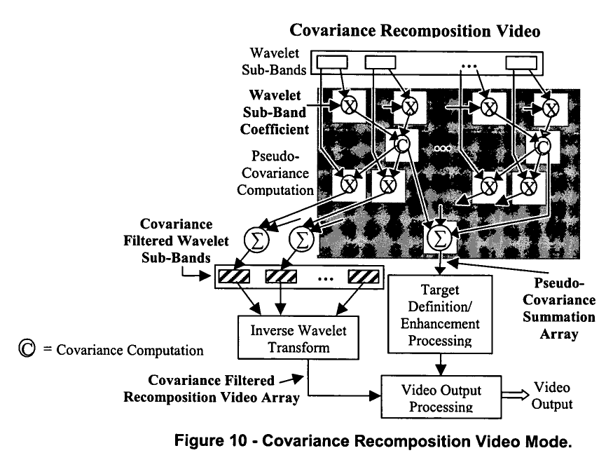

As stated earlier, this mode of operation performs the Pseudo-covariance computation as in the Direct Video Mode. In addition, other processing is accomplished in order to produce a video array of filtered Wavelet video. The array is the result of an Inverse Wavelet Transform Computation operating on filtered Wavelet Sub-Band information. The process is shown in FIG. 10.

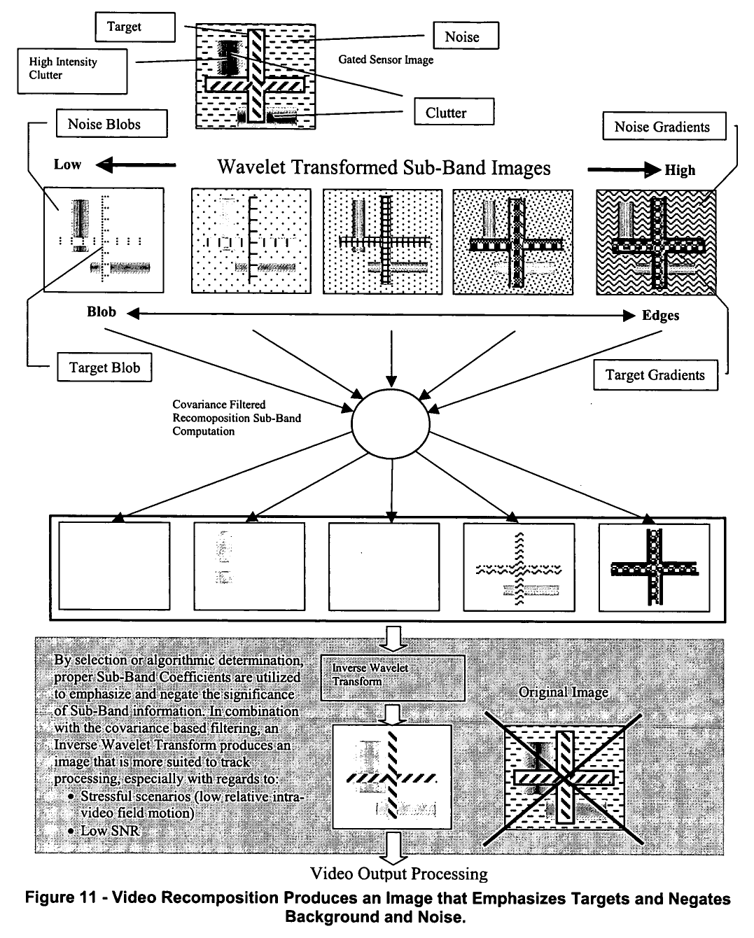

The Wavelet Sub-Band Coefficient Filtering is followed by the Wavelet Sub-Band Covariance Filtering process. For each Covariance Sub-Band pair computation, pixels of associated Sub-Band elements are multiplied by the pixel covariance coefficient and summed with previous computations of other covariance Sub-Band pairs. This process produces a Wavelet Sub-Band set that is then Inverse Wavelet Transformed. The result is an image that has been recomposed from filtered imagery. This algorithm is depicted in FIG. 11.

In this figure, the conceptual resultant video depicts a well-defined target and vastly reduced background clutter and noise. Though this is not illustrated, depending upon target and background characteristics, all background clutter and noise could be totally negated. With greater SNR and non-competing potential target objects, this would achieve significantly improved track performance over current technology.

By a correct determination of Wavelet Sub-Band Coefficient and Pseudo-Covariance Filtering, selected characteristics of target images can be emphasized and/or selected characteristics of background clutter and noise are able to be negated. Targets are presented clearly without identifiable noise, especially under otherwise stressful conditions. False target regions are further negated when they are rejected in the Target Definition/Enhancement Processing. A clear view of the target is then presented to the Video Output Processing. These processes will generally prove efficient in typical scenarios, while providing particular significance in scenarios of stressful conditions, e.g., low relative intra-video field motion or low Signal-to-Noise Ratio.

Processing Option—Pseudo-Covariance Product Statistical Threshold:

An optional technique that potentially lessens a false target recognition error rate is to implement a mechanism that will statistically negate outlying Pseudo-Covariance pixel values. In other words, Pseudo-Covariance product pixels representing a very low significance. The threshold could be manually set (usually from known parameters of a given scenario) or by an automatic statistically-based algorithm. The statistics are based upon each singular video field's (frame's) current computation. (An algorithm based upon current and past video would incur system reaction delays, but could have potential value, depending on the scenario).

Initially, the Pseudo-Covariance Product array is normalized. A Standard Deviation is then calculated. A lower threshold test is then applied to each pixel location in terms of either Standard Deviation or Z-Score. All pixels of value less than a defined threshold are “zeroed,” representing that no potential target information is located at that spatial location. The threshold is either predetermined for a given scenario or parameter-based, such as a computed Signal-to-Noise Ratio. Since this threshold is statistically based and acting upon a normalized data array, the determination of a threshold has a large tolerance in acting to achieve similar results. This is a process that further increases the potentially affectivity of the TWTE Preprocessor.

Processing Option—Pseudo-Covariance Wavelet Sub-Band Statistical Threshold:

An optional technique that potentially lessens a false target recognition error rate is to implement a mechanism that will statistically negate outlying Pseudo-Covariance pixel values. This is the same technique as described above with the exception that the statistical threshold technique is applied to the high-order Wavelet Transformed Sub-Bands rather than the Pseudo-Covariance product array. This would negate the statistical outlying locations due to noise prior to the Pseudo-Covariance determination. In this case, all values of the Pseudo-Covariance Product array would be considered significant.

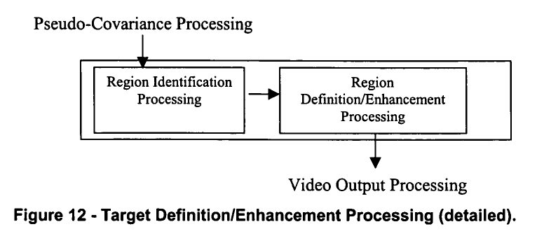

f) Target Definition/Enhancement Processing (see FIG. 12):

The Target Definition/Enhancement Processing is composed of two computational algorithms: 1) Region Identification Processing, and 2) the Region Definition/Enhancement Processing. Their functions are to identify possible regions of target information and to make a choice of these regions as the target to be tracked, negating all others. The latter function includes the enhancement of selected region to provide a sufficient signal for the Track Processor.

The Region Identification Processing outputs all possible regions possessing possible target locations and their arbitrary areas (pixel locations that are grouped together to form arbitrary shapes representing an entire target definition). There may be any number of these regions within the video field (frame). Each determined region may be of any shape and accommodate any number of array elements (one to the total number of array elements).

To accomplish this, each location of the Pseudo-Covariance array is examined for values greater than zero. Values greater than zero are grouped together by determining array areas that are encircled by array elements of value equal to zero, taking into account array edge effects. The TWTE Preprocessor algorithm begins examination of the array elements at the top-left corner, while progressing left-to-right for each array row and marking the array elements with a different identifier for each defined region. During this array element examination, as new elements are located, they are checked for boundary with an existing region and identified accordingly. Should a new region be identified, but later in the array scan be found to coexist with an earlier identified region, the regions elements are joined with identical identifiers and the process restarted.

This process requires an arbitrary number of passes, which depends upon the Pseudo-Covariance array significant locations and goes through each array element until all elements have undergone scrutiny. The result of this process is an array with any number of identified regions of arbitrary shape and element count, each region based upon the values of the Pseudo-Covariance array. (While this algorithm is functional, it is non-deterministic and is an area of research).

The Region Definition/Enhancement subfunction then receives this information and determines the region that is to be tracked. This choice is based upon a designated “aimpoint” within the video field (frame). The aimpoint designation may be any pixel location and is provided by an operator or an external automatic acquisition system, e.g., a radar or target prioritizing process). The region “closest” to the aimpoint is defined to be the region to be tracked. To make this determination, one of three methods is predetermined for implementation. The determination is based upon one of the following:
a) The region possessing an element that is spatially nearest the aimpoint;
b) The region with its centroid spatially nearest the aimpoint; or
c) The region with a Pseudo-Covariance value weighted centroid nearest the aimpoint.

Once a region has been designated as the target, pixels in all other locations are zeroed, negating other possible background clutter and noise. The only pixels containing values other than zero are those representing the target. Those pixels may be modified to a given uniform intensity, gradient intensities, or left as they are observed, as is most effective for the Track Process.

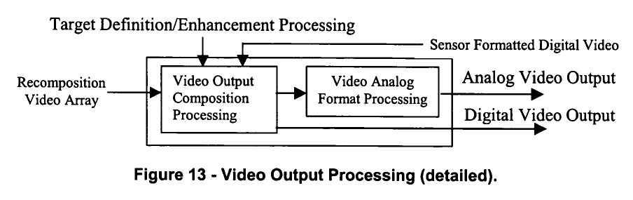

g) Video Output Processing (see FIG. 13):

The Digital Video Output Processing is responsible for output composition and formatting of video for the Track Process and video monitoring. The Video Output Composition Processing receives video information from the Target Definition/Enhancement Processing and Sensor Formatted Digital Video. It combines these video sources such that the enhanced video supersedes the sensor video at pixel locations where the target region exists. All other pixel locations contain the sensor video data multiplied by a gain factor. The gain factor may range from zero to 100 percent. In this way, pixel locations, other than the target, can be negated or presented in a “dimmed” fashion. The gain factor is provided by an external source via the Control/Status Processing Function. The resultant digital video signal is output for use by the Track Process.

The Video Analog Formatting Processing receives digital format video information and converts it to an analog signal appropriate for the Track Process. This analog video format is variable, dependent upon the analog Track Process requirement. The resultant analog signal contains identical information presented in the Digital Video Output.

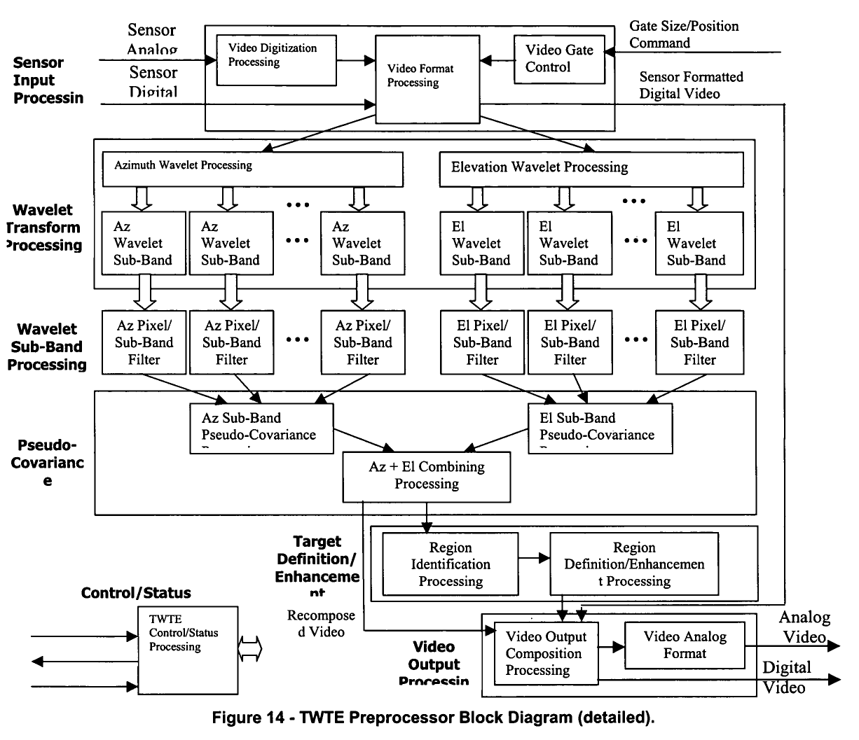

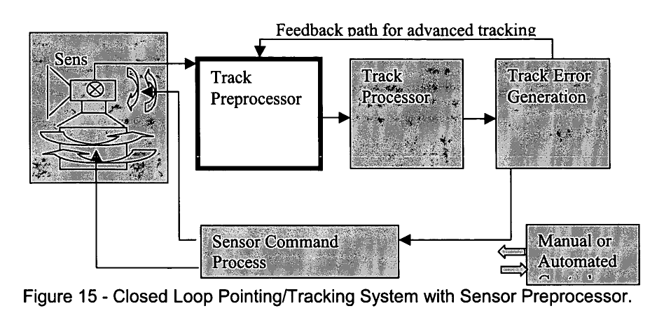

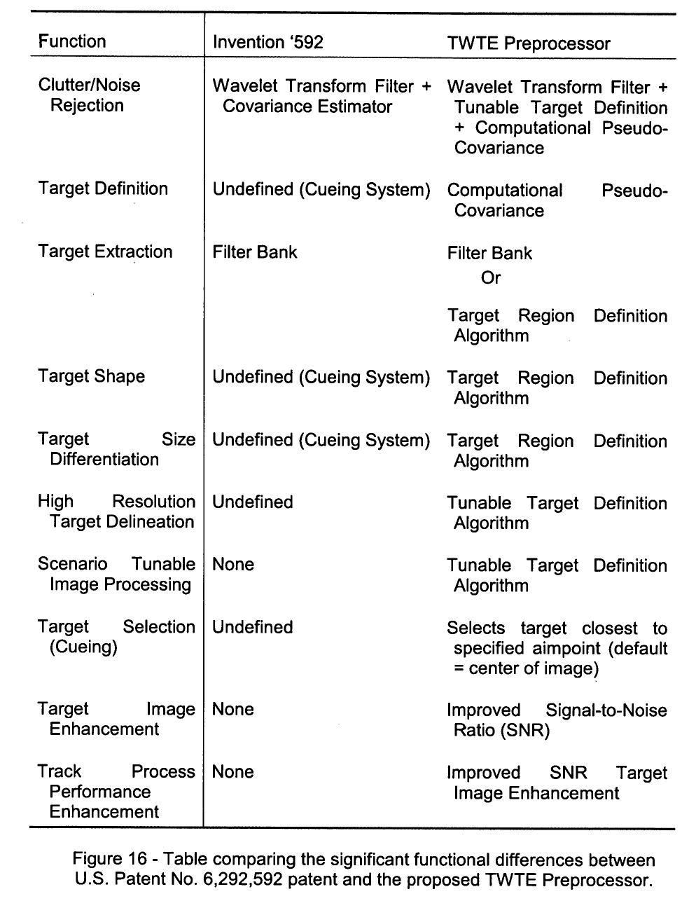

The detailed TWTE Preprocessor Detailed Block Diagram in shown in FIG. 14.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention.

It is, therefore, contemplated that the appended claims will cover such modifications that fall within the scope of the invention.

I claim:

1. A system which processes an input signal from a sensor to reduce or negate background clutter, unwanted target or objects, and noise while presenting an output to an external Track Process inclusive of a target which is selectable by choice of its characteristic image properties so as to improve a tracking system's acquisition/performance.
Means for providing a matrix of data values representing the input video image.
Means for providing a matrix of data values representing the output video image.
Means for defining a target.
Means for extracting a target.
Means for determining a target shape.
Means for differentiating/filtering objects by spatial filtering.
Means for differentiating/filtering objects by temporal filtering.
Means for resolving objects (targets) in high resolution
Means for tuning the image processing to achieve a given scenario.
Means for target selection
Means for target enhancement and augmentation.
Means for improving track system performance.

2. The invention of claim 1 wherein said sensor may be stationary or moved by electro-mechanical means.

3. The invention of claim 1 wherein said sensor may be an array of sensor elements.

4. The invention of claim 1 wherein said sensor may be a radar sensor.

5. The invention of claim 1 wherein said sensor may be an electro-optic sensor.

6. The invention of claim 1 wherein said input video image is a data matrix.

7. The invention of claim 1 wherein said output video image is a data matrix.

8. The invention of claim 1 further including means for designating pixel elements as target definition.

9. The invention of claim 1 further including means for performing a Discrete Wavelet Transform (DWT).

10. The invention of claim 1 further including means for performing an Inverse Discrete Wavelet Transform (IDWT).

11. The invention of claim 1 further including means for calculating a weighted pseudo-covariance matrix of Wavelet Transform Sub Bands on a Sub Band and/or pixel basis.

12. The invention of claim 1 further including means for performing a sparsening by threshold of each Wavelet Sub Band and/or a weighted pseudo-covariance matrix of Wavelet Sub Bands.

13. The invention of claim 1 further including means for performing a sparsening by statistical means of each Wavelet Sub Band and/or a weighted pseudo-covariance matrix of Wavelet Sub Bands.

14. The invention of claim 1 further including means for extracting and the output of designated pixels and their associated values as a target.

15. The invention of claim 1 further including means for determination and the output of designated pixels and their associated values as the shape of the target.

16. The invention of claim 1 further including means for spatial filtering in terms of length, width, and/or area.

17. The invention of claim 1 further including means for differentiating targets/objects on a pixel resolution basis.

18. A system which processes an input signal from a sensor to negate/promote background clutter, target or objects, and noise while presenting an output to an external Track Process The negation/promotion is selectable by choice of characteristic image properties. Pixel properties are adjustable on a pixel basis.

19. The invention of claim 18 wherein the pixel properties are a function of their respective Wavelet Sub Band components. Each component pixel having associated weighting function.
